(19) United States
(12) Patent Application Publication
(10) Pub. No.: US 2010/0269909 A1
(43) Pub. Date: Oct. 28, 2010

(54) DIALYSATE TANK COMPRISING A HEATED DIALYSATE CONTAINER, CORRESPONDING DIALYSIS SYSTEM, AND METHOD

(75) Inventors: Matthias Brandl, Bad Konigshofen (DE); Martin Prinz, Hammelburg (DE)

Correspondence Address: Kenyon & Kenyon LLP, One Broadway, New York, NY, 10004, US

(73) Assignee: FRESENIUS MEDICAL CARE DEUTSCHLAND GMBH, Bad Homburg (DE)

(21) Appl. No.: 12/742,685

(22) PCT Filed: Nov. 21, 2008
(86) PCT No.: PCT/EP2008/009885

§ 371 Date: Jun. 15, 2010

(30) Foreign Application Priority Data
Nov. 22, 2007 (DE) 10 2007 056 237.5

(51) Int. Cl. F17D 3/00; B23P 11/00; B01D 35/18

(52) U.S. Cl. 137/1; 29/428; 210/175; 210/646; 210/85

(57) ABSTRACT

The present invention proposes an apparatus and a method for controlling the temperature of a dialysate, which is present in a dialysate container of a dialysate tank of a dialysis system, in a contact-free manner. It furthermore specifies a method for manufacturing such a dialysate container and system.

### CROSS REFERENCE TO RELATED APPLICATIONS

This is a 371 national phase application of PCT/EP2008/009885 filed Nov. 21, 2008, claiming priority to German Patent Application No. 10 2007 056 237.5 filed Nov. 22, 2007.

### FIELD OF INVENTION

The present invention relates to a dialysate tank and a dialysis system. It further relates to a method for controlling the temperature of dialysate, a method for manufacturing a dialysate tank, as well as a method for manufacturing a dialysis system.

### BACKGROUND OF THE INVENTION

In practice, dialysis apparatuses or systems, such as described, e.g., in WO 96/25214, are known which include a dialysate tank containing a dialyzing liquid in a dialysate container. The dialyzing liquid (dialysate) used is usually heated to a treatment temperature and stored in the dialysate tank prior to the treatment. In the case of a dialysis treatment of the patient, which usually lasts for 4 to 5 hours, some cooling of a dialysate not actively heated, which is limited to approx. 0.5° C. per hour by means of a good thermal insulation of the dialysate tank, e.g., by a thermal jacket, is acceptable.

In long-term treatments of up to 24 hours, however, as may be necessary in intensive-care medicine, such cooling constitutes a drawback. For such applications an active heating of the dialysate or of the patient's blood is required.

For active heating of the dialysate within the meaning of keeping it warm, a heating element is typically used in the prior art which heats the dialysate in direct contact with the latter. As the heating element is usually operated with mains voltage and executed as a so-called Protection Class I, a floating design of the application part (the one part of the dialysis apparatus in electrically conductive contact with the patient) is not possible. The dialysis apparatus may accordingly only be used under restrictions for applications such as those on the open heart.

In order to warm the patient's blood, i. a. a so-called blood warmer for warming the venous blood by means of a thermal coupling via the recirculation tube, or heating tubes are used in the prior art. These methods are in turn not compatible with a floating design of the application part or require the use of additional disposable articles, which results in additional costs and brings about an undesirable contact between blood and one-way article.

### SUMMARY OF THE INVENTION

It is the object of the present invention to specify an improved dialysate tank as well as a dialysis system thereby equipped. Just the same, it is intended to specify a method for manufacturing a dialysate tank and/or a dialysis system, as well as an improved method for controlling or feedback-controlling (the expressions control and feedback control shall be used interchangeably in the present description) the temperature of dialysate.

The object of the invention is achieved through a dialysate tank, which is suitable and intended for use in a dialysis apparatus or in a dialysis system, e.g. of a hemodialysis apparatus (particularly using a so-called Batch System), for the dialysis treatment, for instance a hemodialysis, of a patient. The dialysate tank comprises at least one dialysate container wherein the fresh and/or used, recirculated dialysate is stored. The dialysate tank moreover comprises at least one heat source allowing control or feedback-control of the temperature of the dialysate. The heat source is disposed externally of the dialysate container.

The dialysate container is configured and provided for the dialysate, i.e., for a liquid that is not infused to the patient, so that the dialysate within the meaning of the present invention is different from a substitute liquid or “replacement fluid.” The dialysate container may furthermore be configured and provided for the concurrent accommodation of substantially the total quantity of the dialysate used in one dialysis session or treatment, in which it differs from a flow heater or batch heater. The dialysate container may thus be configured and provided as a storage tank.

“Externally of the dialysate container” means in the context of the present invention that the heat source is not in contact with the dialysate, so that the heat source can not be moistened or wetted by the dialysate. In particular a conduction of current between dialysate and heat source can not take place. “Externally of the dialysate container” may here also be understood to mean geometrically “outside”—i.e., removed from—an inner area of the dialysate container. This may be judged, for instance, in a lateral view or in a lateral projection.

In accordance with the invention, a heat source is understood to be any means whereby it is possible to control a heating of the dialysate or a prevention or delay of a drop in the temperature of the dialysate. The heat source is preferably suited and intended for continuously keeping the dialysate warm at a dialyzing temperature during the dialysis treatment of the patient, particularly the entire treatment. The heat source may be configured such that it will not enable heating of the dialysate up to boiling or sterilization. The heat source may be one of the means that are known to the person having skill in the art, which may include an infrared heat radiation means and a UV radiation emitter or which expressly do not include a like infrared heat radiation means and a like UV radiation emitter.

In accordance with the invention, controlling the temperature of the dialysate is understood to mean that the temperature of the dialysate is raised or that a drop thereof is prevented or delayed. Feedback within the meaning of an open-loop control to the actual temperature, e.g., of the dialysate at a particular point of time, is not necessary according to the invention. The provision and performance of an open-loop control is, however, optionally possible under the invention and thus also encompassed by the present invention. One example for such an open-loop control is described further below in connection with a preferred embodiment.

The heat source is disposed in the dialysate tank of the invention in such a way as to preferably not be in contact with the dialysate container. Contact within the meaning of the invention in particular designates a thermally conductive contact or an electrically conductive contact.

A “contact” between the heat source and the dialysate tank will have to be understood, e.g., as a material touch, in particular an electrically conductive contact in the sense of an electrical connection or the like. This kind of contact does, however, not exist in accordance with the invention. The heat source of the dialysate tank of the invention is rather provided out of contact with the dialysate container. On the other hand, the contactless relation allows for a heat emitted by the heat source to reach an outside of the dialysate container and to thereby—directly or indirectly—influence the temperature of the dialysate. A heat radiation from the heat source towards the dialysate container is thus possible, while a thermal conduction, as between two solid bodies, is not possible in the disposition in accordance with the invention of the heat source in relation to the dialysate container.

By suitably supplying heat to a space or region around the dialysate container—e.g., an air cushion surrounding the dialysate container—cooling of the dialysate container is advantageously prevented. Bringing to a boil or sterilization is not provided in this context.

In the absence of the necessity of a direct heating of the dialysate liquid as carried out in the prior art by means of a heating element that is supplied with mains voltage, the previous floating design of the application part (Type CF) is advantageously preserved in accordance with the invention. As a result, the corresponding dialysis apparatus may furthermore be employed unrestrictedly for applications such as, e.g., on the open heart, which are governed by special requirements.

Another advantage of the dialysate tank of the invention resides in the fact that in the absence of the necessity of a blood heater for the venous recirculation tube, the floating design of the application part (Type CF) is equally not influenced, and additional disposable articles such as tube extensions, as are often necessary for CF blood warmers, are furthermore not required. The latter circumstance advantageously contributes to a decrease in logistic complexity, to a decrease of materials used, to a reduction of problems with safety and hygiene owing to faulty parts, and in connection with these respective points to a reduction of incurred costs.

Thus, in a preferred embodiment proposed, the dialysate container is provided with a casing which reduces a heat loss from the dialysate to the environment. This casing may—as proposed in a further preferred embodiment—be realized, e.g., as a thermal jacket. The casing may surround merely the lateral surfaces—or other surfaces—of the dialysate container, but may also be configured to surround the entire dialysate container—with the exception of recesses for feed and discharge conduits.

The casing of the dialysate container results in a backup or a cushion of air or of another suitable gaseous medium and thus already brings about a decrease of the heat loss and a decrease of the drop in temperature of the dialysate present within the dialysate container. In addition, the space and the volume requiring temperature control by means of the heat source are reduced. It is thus advantageously possible to save energy through a minimization of the required heating power.

The dialysate container may be made of, or comprise, any materials that are known to the person having skill in the art. The material may include a glass, a polymer, a metal, or the like. A material that is particularly also conceivable is a material impenetrable to view or light, in particular a material impermeable to UV and/or infrared radiation.

The heat source may comprise an electrically insulating casing. This casing may equally be impenetrable to view.

If, as proposed in a further preferred embodiment, the heat source is realized entirely or partly as a heating cord, this solution is characterized by a particularly compact arrangement. Moreover the heating cord may, in contrast with other heat sources, be protected particularly well by a dedicated, electrically insulating casing, e.g., by means of silicone. Thus the heat source may in turn be disposed closer to the dialysate container than other types of heat sources without any risk of obliterating the aspired electrical separation between dialysate and heat source. This, too, advantageously contributes to a small and thus space- and material-saving construction, as well as to the necessary observation of only a small spacing between dialysate container and heat source. The latter circumstance contributes to energy savings in heating the vicinity of the dialysate container and thus of the dialysate.

If the heat source, as is proposed in a further preferred embodiment, is supplied via the low-voltage supply of the dialysis system used (for instance, the Genius® 90 Therapy System by the company Fresenius Medical Care), this furthermore advantageously contributes to securing the floating design. This low voltage may in turn be made floating. It can supply the heat source with 30 V and 40 W, for instance.

The same advantage may be obtained by realizing wall portions of the dialysate container of glass, as is provided in a further preferred embodiment.

In another further preferred embodiment of the invention, the dialysate tank comprises at least one temperature sensor for measuring the temperature prevailing in a region or space externally of the dialysate container.

By means of the measurements with the temperature sensor, it is possible to deduct the temperature of the dialysate present within the dialysate container and perform a control or feedback control on it. Thus a heating may, for instance, be paused if a temperature of 37° C. was measured. This enables monitoring of the temperature—control of which may be desired in either direction of warm or cold, as shall be discussed further below—without having to establish direct contact with the dialysate liquid. This contributes to the desired electrical separation between the dialysate and the heat source and furthermore allows for a floating design. In addition, the restriction of the open-loop control to, e.g., 37° C. also allows for a further minimization of the required heating power.

The object of the invention is furthermore also achieved through the dialysis system, which includes a dialysate tank in accordance with the above discussion. Herein all of the above discussed advantages may be achieved undiminished. In order to avoid a repetition of the advantages that may be obtained, reference is made to the above discussion thereof.

The object of the invention is furthermore achieved through a method for controlling the temperature of dialysate present inside of a dialysate container, wherein an external vicinity or a region or space of the dialysate container is heated. Heating, in the present context, is also understood as a measure which does not lead to an increase in temperature but only prevents a drop or an undesirably intense drop of temperature. Here it is possible to use a dialysate tank in accordance with the invention and/or a dialysis system in accordance with the invention. The advantages that may be obtained with the method of the invention encompass all those named in the preceding. Therefore, reference may be made to the above discussion thereof in order to avoid repetitions.

In a particularly preferred development or embodiment of the control method of the invention, the heat emitted by the heat source is controlled—optionally in open-loop control—such that the temperature of the space surrounding the dialysate container will be equal to or lower than the original temperature of the dialysate (i.e., the temperature of the dialysate, for example at the beginning of the dialysis session) within the dialysate container. This maintains the establishment of a separation between fresh and spent or recirculated dialysate within the dialysate container. The establishment of the separating layer is therefore advantageously not interfered with.

Lastly, the object of the invention is also achieved through a manufacturing method. Again, all of the above discussed advantages may be obtained undiminished. In order to avoid a repetition of the obtainable advantages, reference is once again made to the above discussion thereof. The same applies for the equally specified method for manufacturing a dialysis system.

It should be noted that the invention may be used not solely in connection with dialysis. Rather, a heating or keeping warm of liquids or fluids other than a dialysate in a container which is not a dialysate container but in general a liquid or fluid container, is encompassed by the present invention. In particular, the invention thus relates to any kind of—in particular medical—apparatus including a corresponding container with fluid stored therein. The terms “dialysate”, “dialysis apparatus”, “dialysate tank”, and “dialysis” as used in the description and in the appended claims should therefore is understood correspondingly broadly and also not in relation with dialysis.

### BRIEF DESCRIPTION OF THE DRAWINGS

The present invention shall in the following be explained in more detail by referring to the drawings by way of an exemplary embodiment in accordance with the invention.

FIG. 1 shows in a cross-sectional view a schematically simplified, partially represented dialysis system in accordance with the invention, including a dialysate tank which is also represented in a simplified manner.

### DETAILED DESCRIPTION OF THE DRAWINGS

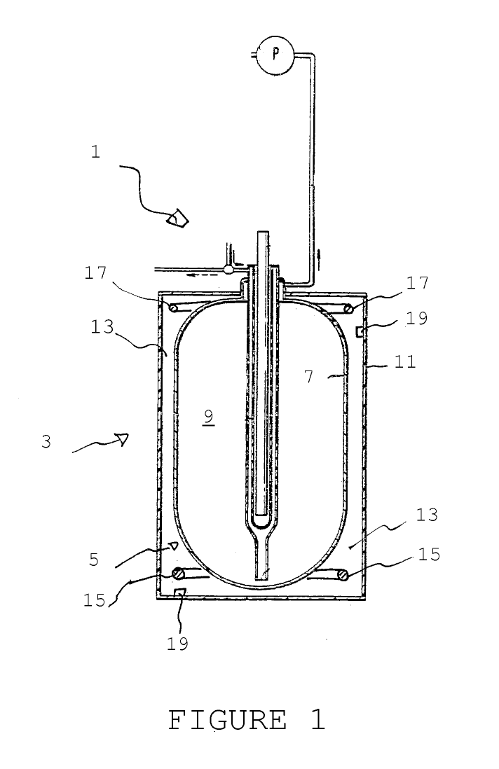

FIG. 1 shows details of a dialysis system 1 in accordance with the present invention in schematically simplified representation. The dialysis system 1 comprises a dialysate tank 3 in accordance with the invention which, in turn, comprises a dialysate container 5 having a casing 7 and an inner space 9. Irrespective of other design features, the dialysate container 5 may be disposed on the interior of the dialysate tank 3, as is shown purely exemplarily in FIG. 1. In addition to the dialysate tank 3, the dialysis system 1 comprises conduits disposed inside and outside of the dialysate tank 3 which are not related to the present invention and are therefore indicated but not designated in FIG. 1.

The dialysate tank 3 comprises a structure 11 which is realized as a jacket surrounding the inner space 9. The structure 11 is made of, or comprises, a thermally insulating material and surrounds both the dialysate container 5 with its inner space 9 and a space 13 provided between the dialysate container 5 and the structure 11.

Inside the space 13 a lower heat source 15 is arranged which has the form of a heating cord horizontally surrounding the periphery of the lower region of the dialysate container 5. The heating cord extends externally of the dialysate container 5 and is spaced from the casing 7 of the dialysate container 5 such that an electrical conduction between the heating cord as the heat source 15 and the dialysate container 5 does not come about. The heat source 15 may be realized as a simple ring. It may, however, for example also be realized in two parts and may also comprise, in addition to the heating cord shown in sectional view in the lower region, a second heating cord 17 provided in the upper region of the dialysate container 5. It may moreover be wound in several turns along a horizontal extension of the dialysate container 5 in a threaded or helical manner, or be realized in any other manner deemed suitable by a person having skill in the art.

It should be noted that supply lines to the heat source—which are not represented in FIG. 1—may furthermore be routed into or out of the dialysate tank 3 so that they equally do not have to be in contact with the dialysate container 5.

By means of the heat source 15, 17, the space 13 is thus heated to a suitable temperature or kept at this temperature or at another temperature which is, for instance, lower or dropping in the course of time. Monitoring of the temperature prevailing inside the space 13 may be carried out, e.g., by means of one or several temperature sensors 19. Reporting from the temperature sensors for the purpose of controlling the heat source 15, 17 is also possible.

The present invention thus for the first time proposes an apparatus and a method for the contact-free control of the temperature of a dialysate present in a dialysate container of a dialysate tank. It furthermore specifies a method for manufacturing such a dialysate container and system in accordance with the invention.

1-17. (canceled)

18. A dialysate tank for use in a dialysis system, said dialysate tank comprising:
at least one dialysate container for storing a dialysate, and
at least one heat source disposed external to the at least one dialysate container for controlling the temperature of the dialysate, wherein the at least one heat source is not in contact with the at least one dialysate container.

19. The dialysate tank according to claim 18, further comprising:
a structure surrounding at least a portion of the at least one dialysate container; and
a space between the at least one dialysate container and the surrounding structure, wherein heat may be generated by the at least one heat source in the space.

20. The dialysate tank according to claim 18, wherein the at least one heat source comprises a heating cord.

21. The dialysate tank according to claim 18, wherein the at least one heat source is supplied by a voltage supply of the dialysis system.

22. The dialysate tank according to claim 19, wherein the structure surrounding the at least one dialysate container comprises an insulating jacket.

23. The dialysate tank according to claim 19, further comprising:
at least one temperature sensor for measuring a temperature in the space between the at least one dialysate container and the structure.

24. A dialysis system including a dialysate tank according to claim 18.

25. A method for controlling the temperature of a dialysate present in at least one dialysate container, comprising:
providing a dialysate tank comprising:
at least one dialysate container for storing a dialysate, and
at least one heat source disposed external to the dialysate container for controlling the temperature of the dialysate, wherein the at least one heat source is not in contact with the dialysate container;
providing a dialysate within the at least one dialysate container; and
heating an external vicinity of the at least one dialysate container with the at least one heat source to control the temperature of the dialysate.

26. The method according to claim 25, wherein the dialysate tank further comprises:
a structure surrounding at least a portion of the at least one dialysate container; and
a space between the at least one dialysate container and the surrounding structure, wherein heating the external vicinity of the at least one dialysate container occurs within the space.

27. The method according to claim 26, further comprising the step of:
controlling the heat emitted by the at least one heat source such that a temperature of the space surrounding the at least one dialysate container is equal to or lower than an original temperature of the dialysate inside the dialysate container.

28. A method for manufacturing a dialysate tank for use in a dialysis system, comprising:
providing a dialysate tank comprising at least one dialysate container for storing a dialysate; and
disposing at least one heat source external to the at least one dialysate container for controlling the temperature of the dialysate such that the at least one heat source is not in contact with the at least one dialysate container.

29. The method according to claim 28, further comprising:
surrounding at least a portion of the at least one dialysate container with a structure such that a space remains between the at least one dialysate container and the surrounding structure, wherein heat may be generated by the at least one heat source in the space.

30. The method according to claim 28, wherein the at least one heat source comprises a heating cord.

31. The method according to claim 28, further comprising:
supplying the at least one heat source with power from a voltage supply of a dialysis system.

32. The method according to claim 29, wherein the structure surrounding the at least one dialysate container comprises an insulating jacket.

33. The method according to claim 29, further comprising:
providing at least one temperature sensor for measuring a temperature in the space between the structure and the at least one dialysate container.

34. The dialysate tank according to claim 21, wherein the voltage supply is a low-voltage supply.

35. The method according to claim 31, wherein the voltage supply is a low-voltage supply.

36. The method according to claim 29, further comprising:
generating heat with the at least one heat source within the space.

37. The method according to claim 26, further comprising:
measuring a temperature in the space between the structure and the at least one dialysate container.
